(19) United States
(12) Patent Application Publication
(10) Pub. No.: US 2025/0355815 A1
(43) Pub. Date: Nov. 20, 2025

(54) SYSTEMS, METHODS, AND DEVICES FOR WIRELESS CHANNEL SOUNDING BASED OCCUPANCY DETECTION

(71) Applicant: Cypress Semiconductor Corporation, San Jose, CA (US)

(72) Inventors: Patrick Cruise, Dana Point, CA (US); Sivaram Alukuru Trikutam, Mountain View, CA (US); Claudio Rey, Chandler, AZ (US); Arvind Sridharan, San Diego, CA (US)

(73) Assignee: Cypress Semiconductor Corporation, San Jose, CA (US)

(21) Appl. No.: 19/067,712

(22) Filed: Feb. 28, 2025

Related U.S. Application Data
(60) Provisional application No. 63/647,546, filed on May 14, 2024.

(51) Int. Cl. G06F 13/10; G01S 13/76

(52) U.S. Cl. CPC G06F 13/10; G01S 13/765; G06F 2213/40

(57) ABSTRACT

Systems, methods, and devices locate and identify wireless devices within operational environments such as automobile environments. Methods include determining, using one or more processors of a central wireless device, one or more identifiers associated with a peripheral wireless device, and performing, using the one or more processors, a wireless exchange with the peripheral wireless device, the wireless exchange comprising one or more channel sounding operations compatible with a wireless communications protocol. Methods further include determining a plurality of estimated distances based on channel sounding data obtained by the central wireless device and received from a plurality of remote wireless devices based on the wireless exchange, and determining a location and identity of the peripheral wireless device within an operational environment based on the plurality of estimated distances and the one or more identifiers.

### CROSS-REFERENCE TO RELATED APPLICATIONS

This application claims priority under 35 U.S.C. § 119(e) to U.S. Provisional Application No. 63/647,546, filed May 14, 2024, which is incorporated by reference herein in its entirety for all purposes.

### TECHNICAL FIELD

This disclosure relates to wireless devices, and more specifically, to entity detection based on features of such wireless devices.

### BACKGROUND

Wireless devices may be implemented within a variety of operational environments. For example, wireless devices, such as smartphones and smart devices, may perform various operations and execute applications as they are brought by a user across various operational environments, such as into and/or out of an automobile that supports wireless connectivity. However, conventional techniques for wireless systems and devices implemented within the operational environment to detect and locate wireless devices and their associated users remain limited because they are not able to efficiently perform occupancy detection operations and identity determination operations without requiring additional hardware resources and/or verification operations.

### BRIEF DESCRIPTION OF THE DRAWINGS

FIG. 1 illustrates diagram of a system for entity detection, configured in accordance with some embodiments.

FIG. 2 illustrates diagram of another system for entity detection, configured in accordance with some embodiments.

FIG. 3 illustrates diagram of a device for entity detection, configured in accordance with some embodiments.

FIG. 4 illustrates diagram of a method for entity detection, performed in accordance with some embodiments.

FIG. 5 illustrates diagram of another method for entity detection, performed in accordance with some embodiments.

FIG. 6 illustrates diagram of an additional method for entity detection, performed in accordance with some embodiments.

FIG. 7 illustrates diagram of another method for entity detection, performed in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as not to unnecessarily obscure the described concepts. While some concepts will be described in conjunction with the specific examples, it will be understood that these examples are not intended to be limiting.

Wireless devices may be configured to communicate with each other via one or more wireless communications protocols. For example, wireless devices may establish connections and exchange data using a Bluetooth protocol or a Wi-Fi protocol. As will be discussed in greater detail below, such wireless connections may be configured to support channel sounding features that provide ranging information for wireless devices using that wireless connection. Accordingly, in addition to data exchange operations, such wireless connections may also support various ranging features.

In some operational environments, additional information regarding wireless devices and associated entities within the operational environment may be desired. For example, a head unit of an automobile may be in communication with one or more wireless devices, such as a smartphone of a user, or some other device such as a wireless headset or watch. Conventional techniques for locating such wireless devices within the operational environment remain limited because they are not able to perform both location determination and identity verification for such wireless devices, or they require additional hardware resources for features underlying such operations, such as button presses, or biometric techniques.

Embodiments disclosed herein provide wireless devices with the ability to perform wireless device location operations and identity determination/verification operations using channel sounding features of the wireless connection and additional data, such as application data. As will be discussed in greater detail below, channel sounding information may be used in combination with application data or one or more other data sources to combine device location capabilities and identity determination/verification capabilities, and to provide, for example, a head unit of an automobile with the ability to efficiently identify a wireless device and associated user as well as physically locate the wireless device within the operational environment. Moreover, such identity and location information may be leveraged to apply settings and parameters specific to that user at the identified location within the operational environment.

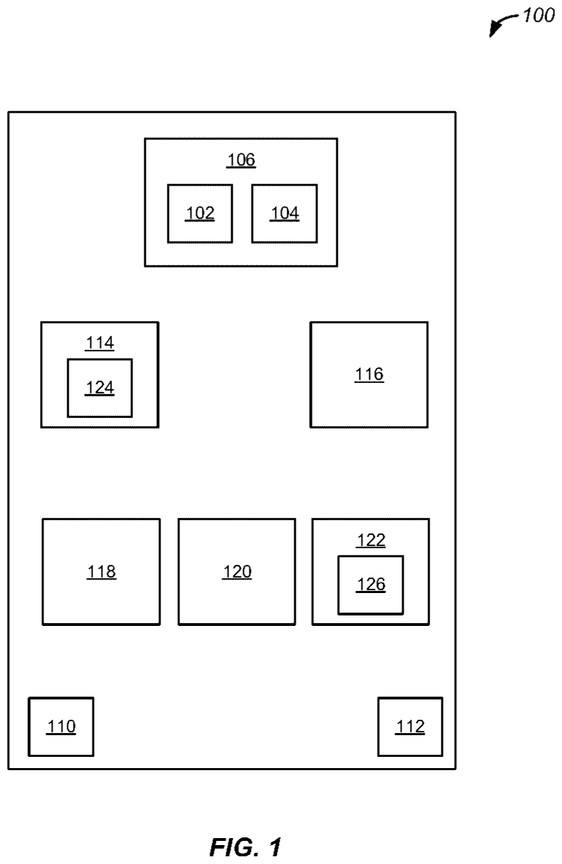

FIG. 1 illustrates diagram of a system for entity detection, configured in accordance with some embodiments. As similarly discussed above, a system, such as system 100 is configured to combine the identification features and location features to identify and locate a wireless device within an operational environment, and also apply custom settings based on such identity and location. In some embodiments, the operational environment may be an automotive environment. For example, system 100 may be an automobile. Moreover, as will be discussed in greater detail below, a central wireless device of the automobile may be configured to use, among other wireless features, channel sounding capabilities of wireless devices to identify wireless devices entering within a range of the automobile and locate the wireless devices within the car. Furthermore, the central wireless device may also apply local and custom settings at the determined location and specific to a particular user.

As discussed above, system 100 may be an automobile that may have multiple seating positions such as seat 114, seat 116, seat 118, seat 120, and seat 120. Moreover, such seats may be configured to seat users that may have associated wireless devices, such as first wireless device 124 and second wireless device 126. Accordingly, as shown in FIG. 1, a first user may be sitting in seat 114 and have first wireless device 124 which may be a smart device such as a smartphone. Moreover, a second user may be sitting in seat 122 and have second wireless device 126 which may be a wireless headset or other type of device. In various embodiments, both wireless devices are configured to be compatible with one or more wireless communications protocols, such as a Bluetooth protocol. Accordingly, each of first wireless device 124 and second wireless device 126 may be Bluetooth devices capable of transmitting and receiving data using Bluetooth wireless connections.

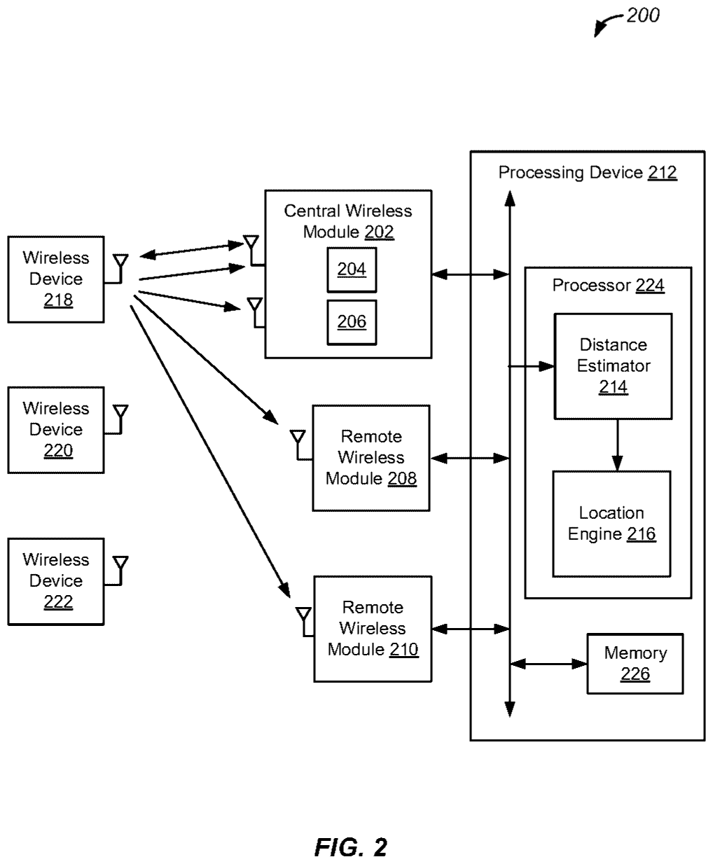

In various embodiments, system 100 additionally includes central wireless device 106 which is configured to perform at least some of the entity identification and location operations disclosed herein. As will be discussed in greater detail below with reference to FIG. 2, central wireless device 106 is configured to include processing device 102 which includes one or more processors and a memory that may be configured to perform processing operations for central wireless device 106, such as entity identification operations used to determine an identify of an entity, as well as location operations that may be performed based on triangulation operations, or other suitable computations as will be discussed in greater detail below. In one example, central wireless device 106 is a head unit included in an infotainment system of an automobile. Thus, according to some embodiments, processing device 102 is also configured to execute one or more applications used by system 100, such as applications specific to an automobile manufacturer, or other applications used to stream media and audio data.

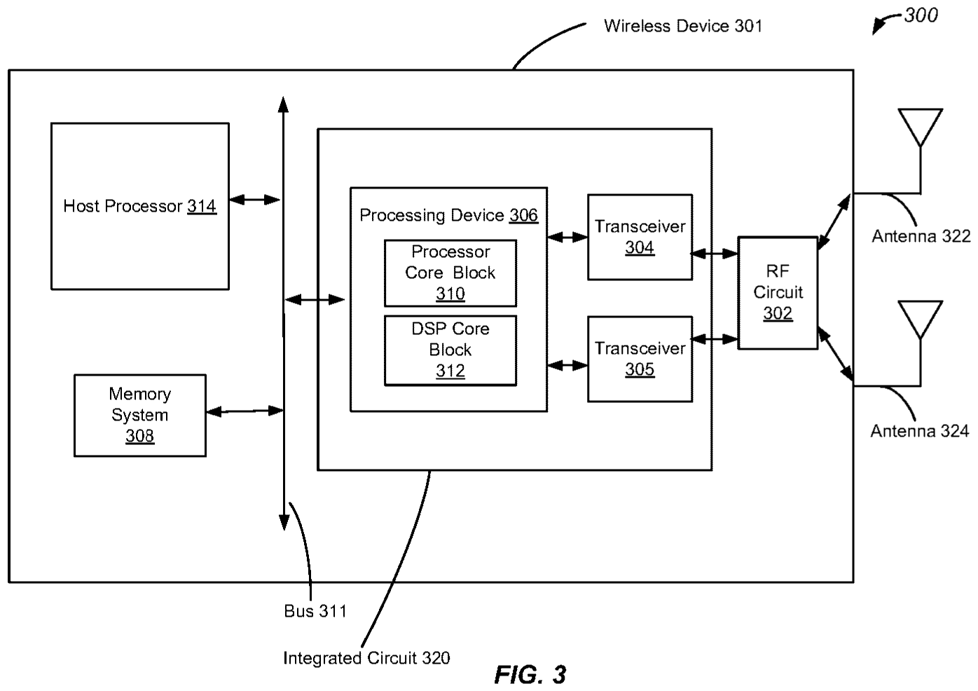

In various embodiments, central wireless device 106 may include additional hardware and software for wireless communication, such as wireless module 104 that includes one or more wireless transceivers and associated processing logic, as will be discussed in greater detail below with reference to FIG. 2 and FIG. 3. In some embodiments, wireless module 104 is configured to perform data transmission and reception operations used for wireless connection establishment as well as data packet exchange. Wireless module 104 is also configured to support channel sounding capabilities of such wireless connections. Accordingly, transmission and reception of tones during a tone exchange may be accomplished via wireless module 104, and received data may be provided to processing device 102 for analysis.

System 100 further includes remote wireless modules such as first remote wireless module 110 and second remote wireless module 112. As will be discussed in greater detail below, first remote wireless module 110 and second remote wireless module 112 are configured to include one or more wireless transceivers and associated processing logic configured to receive wireless signals in accordance with one or more wireless communications protocols. More specifically, first remote wireless module 110 and second remote wireless module 112 may be configured as Bluetooth wireless devices. Moreover, first remote wireless module 110 and second remote wireless module 112 may be configured to observe channel sounding operations performed between central wireless device 106 and first wireless device 124 and/or second wireless device 126, and may be further configured to transmit the observed data to central wireless device 106 for analysis. Accordingly, central wireless device 106 may obtain channel sounding data from itself as well as first remote wireless module 110 and second remote wireless module 112, and may use the combined channel sounding data for location operations for a particular wireless device.

FIG. 2 illustrates diagram of another system for entity detection, configured in accordance with some embodiments. As similarly discussed above, a system, such as system 200 is configured to combine the identification features and location features to identify and locate a wireless device within an operational environment, and also apply custom settings based on such identity and location. As will be discussed in greater detail below, multiple wireless modules may be included in such an operational environment to provide wireless connection functionalities as well as location determination functionalities using channel sounding capabilities of wireless devices.

As similarly discussed above, system 200 may include various wireless devices, such as wireless device 218, wireless device 220, and wireless device 222. Such wireless devices may include hardware and software, such as processors, transceivers, and memory, configured to support transmitting and receiving data in accordance with a wireless communications protocol, such as a Bluetooth protocol. For example, wireless device 218 may be a smartphone, wireless device 220 may be an additional smartphone, and wireless device 222 may be a smartwatch. It will be appreciated that the wireless devices may be any suitable wireless device.

As shown in FIG. 2, the wireless devices may perform data exchange operations with various wireless modules implemented within an operational environment. As discussed above, such an operational environment may be an automobile or other vehicle. In some embodiments, the operational environment may be a system of Internet of Things (IoT) devices. Accordingly, system 200 may include central wireless module 202 which is configured to perform connection establishment operations with wireless devices as well as perform ranging operations. Accordingly, central wireless module 202 may establish a wireless connection with a wireless device, such as wireless device 218, and data exchange operations may be performed. In one example, such data exchange operations may include one or more login operations or other operations for an application executed by processing device 212. For example, wireless device 218 may be a smartphone, and once a wireless connection has been established, an application executed on wireless device 218 may communicate with an application executed on processing device 212 to exchange authentication information and log the user into the application executed on processing device 212, which may be an application created by an automobile manufacturer. During such a login process, one or more identifiers may be exchanged that provide identifiers unique to the user of wireless device 218.

In various embodiments, central wireless module 202 additionally supports ranging operations using channel sounding features of the established wireless connections. For example, a tone exchange may be initiated between central wireless module 202 and wireless device 218 in which wireless device 218 emits a designated wireless signal, and central wireless module 202 receives the signal to collect data which may subsequently be used to identify one or more differences in the signal based on phase and/or time parameters, and such phase and/or time parameters may be used to infer ranging information, such as an estimated distance between central wireless module 202 and wireless device 218. It will be appreciated that any suitable ranging technique may be used. In one example, a channel sounding exchange of a Bluetooth communications protocol is used.

In various embodiments, central wireless module 202 may include different processing elements and logic to support different operations. More specifically, first processing elements may be used for data exchange operations for a wireless connection. Such first processing elements may be included in first processor core 204. Moreover, second processing elements may be used for channel sounding-based ranging operations. Such second processing elements may be included in second processor core 206. In various embodiments, partitioning of such features on different cores facilitates simultaneous execution of both functionalities in parallel. Moreover, while central wireless module 202 is shown as separate from processing device 212, it will be appreciated that both central wireless module 202 and processing device 212 may be included in a single wireless device, such as a central wireless device discussed above with reference to FIG. 1.

System 200 additionally includes various remote wireless modules such as remote wireless module 208 and remote wireless module 210. As similarly discussed above with reference to FIG. 1, remote wireless module 208 and remote wireless module 210 may be implemented within system 200 at physical locations different than that of central wireless module 202. In one example, they are located at positions configured to provide triangulation capabilities for ranging operations. In an example where system 200 is an automobile, central wireless module 202 may be positioned at the front of the automobile in a head unit, and remote wireless module 208 and remote wireless module 210 may be positioned towards the back of the automobile on opposing sides.

Each of remote wireless module 208 and remote wireless module 210 may include transceivers and associated processing hardware and software configured to observe wireless signals within system 200, and in accordance with a designated wireless communications protocol. More specifically, remote wireless module 208 and remote wireless module 210 may each be configured to observe a tone exchange that occurs during channel sounding operations performed between central wireless module 202 and wireless device 218. Accordingly, channel sounding operations may be performed between central wireless module 202 and wireless device 218, and both remote wireless module 208 and remote wireless module 210 may observe such operations and obtain data including phase and/or time parameters. In this way, during a single tone exchange for channel sounding operations, each of central wireless module 202, remote wireless module 208, and remote wireless module 210 may generate their own ranging data for their respective physical locations, and such ranging data may include raw phase and/or time data. In various embodiments, central wireless module 202 may send a synchronization signal to remote wireless module 208 and remote wireless module 210 to synchronize their observation operations. Such a synchronization signal may be sent via a bus or other communications interface.

System 200 further includes processing device 212 which is configured to perform processing operations for applications executed by system 200, and also perform identity and location determination operations. Accordingly, processing device 212 may be communicatively coupled to central wireless module 202, remote wireless module 208, and remote wireless module 210 via a bus or other communications interface. Processing device 212 may include one or more processors, such as processor 224, which is configured to execute one or more applications for system 200. For example, applications executed on a head unit of an automobile may be executed by processor 224. System 200 further includes memory 226 which may include a memory device configured to store data underlying the operations performed by processing device 212.

In various embodiments, processor 224 is also configured to receive data from central wireless module 202, remote wireless module 208, and remote wireless module 210. In this way, processor 224 is configured to aggregate data from central wireless module 202, remote wireless module 208, and remote wireless module 210 that was generated based on a single channel sounding tone exchange. As discussed above, such aggregated data may include raw phase and/or time data generated by each of the wireless modules. In various embodiments, processor 224 includes processing elements configured to implement distance estimator 214 which is configured to generate estimated distances based on the received data. Accordingly, distance estimator 214 may be configured to generate an estimated distance for each set of raw data for each wireless module, where such an estimated distance is inferred based on phase and/or time difference parameters included in the raw phase and/or time data. As similarly discussed above, any suitable distance estimation algorithm may be implemented. For example, phase measurements may be used with a Fast Fourier Transform (FFT) distance estimation algorithm. In another example, machine learning models, such as a trained neural network, may be utilized for distance estimation. Moreover, time data, such as time of flight and round trip time measurements may be used for distance estimation.

In various embodiments, processor 224 includes processing elements configured to implement location engine 216 which is configured to generate an estimated location of wireless device 218 based on the estimated distances determined by distance estimator 214. Accordingly, location engine 216 is configured to perform one or more triangulation operations to triangulate a physical position of wireless device 218 based on the three estimated distances associated with central wireless module 202, remote wireless module 208, and remote wireless module 210. It will be appreciated that any suitable triangulation technique may be used. For example, the three estimated distances may be provided as an input to any suitable triangulation algorithm to generate an estimated location. It will be appreciated that while embodiments disclosed herein refer to triangulation, trilateration algorithms may also be used, and the two are used interchangeably herein as examples of location estimation. Moreover, while system 200 includes three wireless modules, any suitable number of wireless modules may be used. For example, five wireless modules may be used and location engine 216 may estimate a physical location based on five estimated distances.

In various embodiments, processing device 212 is additionally configured to generate an determined identity and an estimated position of wireless device 218 and its associated user within a designated operational environment, and also further configured to apply one or more preference parameters at the determined location. In some embodiments, processing device 212 may map the estimated location generated by location engine 216 to a designated location represented in a spatial mapping stored in memory 226. For example, the estimated location generated by location engine 216 may be a physical location within a two-dimensional plane. Processing device 212 may use a designated mapping to map that estimated location to one or more designated locations native to the operational environment of system 200 based on a mapping of such physical locations to defined boundaries of defined locations represented in the two-dimensional plane. Such a designated mapping may have been generated by an entity, such as a manufacturer based on known physical dimensions of system 200 and previously determined definitions of locations and associated boundaries.

In the example of system 200 being an automobile, such designated locations may correspond to seating locations, such as the seats discussed above with reference to FIG. 1. In this way, the location estimated by location engine 216 may be mapped to a designated location within system 200. Such designated locations may each have a set of preference parameters that may be customizable. For example, each seat may have climate control settings, seat configuration settings, auditory settings for associated speakers, as well as mirror configuration settings. Existing sets of preference parameters may have been generated by a user and stored in a data table. Accordingly, processing device 212 may be configured to use the previously determined identify to query the preference parameters and obtain a set of preference parameters for the identified user. Moreover, processing device 212 may be further configured to apply the set of preference parameters at the determined designated location. In this way, processing device 212 may use an identity and location determined based on wireless connection and channel sounding operations to identify and apply a custom set of preference parameters at a user's location within the automobile.

FIG. 3 illustrates diagram of a device for entity detection, configured in accordance with some embodiments. More specifically, FIG. 3 illustrates an example of a system, such as system 300, that includes wireless device 301. It will be appreciated that wireless device 301 may be one of any of the wireless devices and modules discussed above with reference to FIG. 1 and FIG. 2, such as central wireless device 106, as well as central wireless module 202 and processing device 212.

In various embodiments, wireless device 301 includes one or more transceivers, such as transceiver 304 and transceiver 305. In one example, system 300 includes transceiver 304 which is configured to transmit and receive signals using an antenna such as antenna 322 or antenna 324. As noted above, transceiver 304 and/or transceiver 305 may be a Bluetooth transceiver compatible with a Bluetooth communications protocol. Accordingly, transceivers may each include a modulator and demodulator as well as one or more buffers and filters, that are configured to generate and receive signals via antenna 322 and/or antenna 324. While various embodiments are described with reference to Bluetooth communications protocols, it will be appreciated that any suitable protocol may be used.

In various embodiments, system 300 further includes processing device 306 which may include logic implemented using processing elements and/or one or more processor cores. Accordingly, processing device 306 includes one or more components configured to implement a medium access control (MAC) layer that is configured to control hardware associated with a wireless transmission medium. In one example, processing device 306 may include processor core block 310 that may be configured to implement a driver, such as a Bluetooth driver. Processing device 306 may further include digital signal processor (DSP) core block 313 which may be configured to include microcode.

In various embodiments, processor core block 310 comprises multiple processor cores which are each configured to implement specific portions of a wireless protocol interface. For example, a Bluetooth protocol may be implemented using a Bluetooth stack in which software is implemented as a stack of layers, and such layers are configured to compartmentalize specific functions utilized to implement the Bluetooth communications protocol. In various embodiments, a host stack includes layers for a Bluetooth network encapsulation protocol, radio frequency communication, service discovery protocol, as well as various other high level data layers. Moreover, a controller stack includes a link management protocol, a host controller interface, a link layer which may be a low energy link layer, as well as various other timing critical layers. As discussed above, processor core block 310 may include multiple processor cores that may be used to separately implement data exchange and channel sounding operations. In various embodiments, multiple link-layer cores may be configured to implement the different channel sounding operations and data exchange operations. Accordingly, different link-layer cores may be configured to implement different wireless channel operations.

System 300 further includes radio frequency (RF) circuit 302 which is coupled to antenna 322 and antenna 324. In various embodiments, RF circuit 302 may include various components such as an RF switch, a diplexer, and a filter. While FIG. 3 illustrates system 300 as having two antennas, it will be appreciated that system 300 may have a single antenna, or any suitable number of antennas. Accordingly, RF circuit 302 may be configured to select an antenna for transmission/reception, and may be configured to provide coupling between the selected antenna, such as antenna 322, and other components of system 300 via a bus, such as bus 311. While one RF circuit is shown, it will be appreciated that wireless device 301 may include multiple RF circuits. Accordingly, each of multiple antennas may have its own RF circuit.

System 300 includes memory system 308 which is configured to store one or more data values associated with identity and location determination operations discussed above and in greater detail below. Accordingly, memory system 308 includes storage device, which may be a non-volatile random-access memory (NVRAM) configured to store such data values, and may also include a cache that is configured to provide a local cache.

In various embodiments, system 300 further includes host processor 314 which is configured to implement processing operations implemented by system 300. More specifically, host processor 314 may be configured to include one or more processing devices comprising processing elements that are configured to implement identity and location determination operations discussed above and in greater detail below. Moreover,

It will be appreciated that one or more of the above-described components may be implemented on a single chip, or on different chips. For example, transceiver 304, transceiver 305, and processing device 306 may be implemented on the same integrated circuit chip, such as integrated circuit 320. In another example, transceiver 304, transceiver 305, and processing device 306 may each be implemented on their own chip, and thus may be disposed separately as a multi-chip module or on a common substrate such as a printed circuit board (PCB). It will also be appreciated that components of system 300 may be implemented in the context of a vehicle such as an automobile. Accordingly, some components, such as integrated circuit 320, may be implemented in a first location, while other components, such as antenna 322, may be implemented in second location, and coupling between the two may be implemented via a coupler such as RF circuit 302.

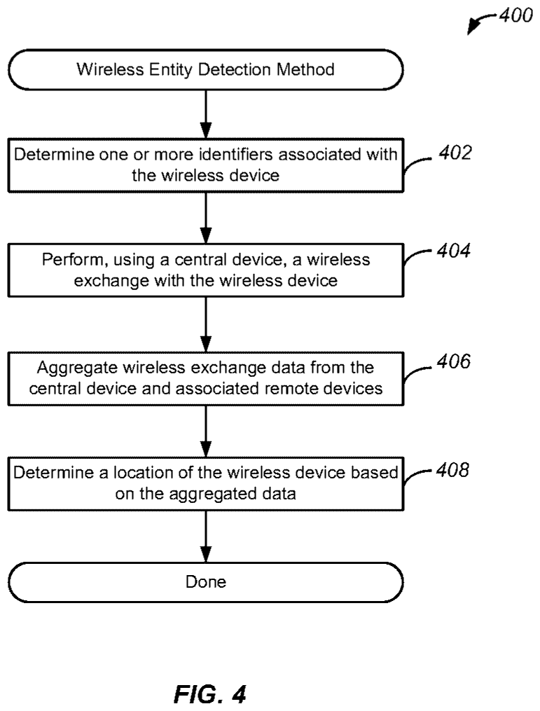

FIG. 4 illustrates diagram of a method for entity detection, performed in accordance with some embodiments. As similarly discussed above, identification features and location features of wireless connections may be used to identify and locate an entity, such as a wireless device, within an operational environment, and also apply custom settings based on such identity and location. As will be discussed in greater detail below, a method, such as method 400, may be performed to implement such identification and location, as well as facilitate the application of custom parameters and settings.

Method 400 may perform operation 402 during which one or more identifiers associated with a wireless device may be determined. As similarly discussed above, such identifiers may be obtained once a peripheral wireless device associated with the entity enters within range of the operational environment and a wireless connection is established. In one example, such identifiers may be obtained as part of wireless connection establishment, or some other validation or authentication operation. The one or more identifiers may be unique identifiers that are specific to the entity, which may be a user of the wireless device.

Method 400 may perform operation 404 during which a wireless exchange may be performed between a central wireless device and the peripheral wireless device. In various embodiments, the wireless exchange may include one or more ranging operations using ranging features of the established wireless connection. Accordingly, during operation 404 the peripheral wireless device and the central wireless device may exchange signals, and the central wireless device may obtain measurements including phase and/or time data. As discussed above, various remote wireless devices may also observe the exchange and may also obtain measurements including phase and/or time data.

Method 400 may perform operation 406 during which wireless exchange data may be aggregated from the central wireless device and associated remote wireless devices. Accordingly, the measurements made by the central wireless device and the remote wireless devices may be aggregated at a processing device such that all measurements for the wireless exchange have been collected and stored for subsequent analysis.

Method 400 may perform operation 408 during which a location of the peripheral wireless device may be determined based on the aggregated data. Accordingly, the processing device may use the measurement data to generate estimated distances and an estimated position of the peripheral wireless device within the operational environment. As similarly discussed above, such an estimated location may be mapped to a designated location within the operational environment, and the previously determined identity may be used to identify a plurality of settings to be applied to the designated location within the operational environment.

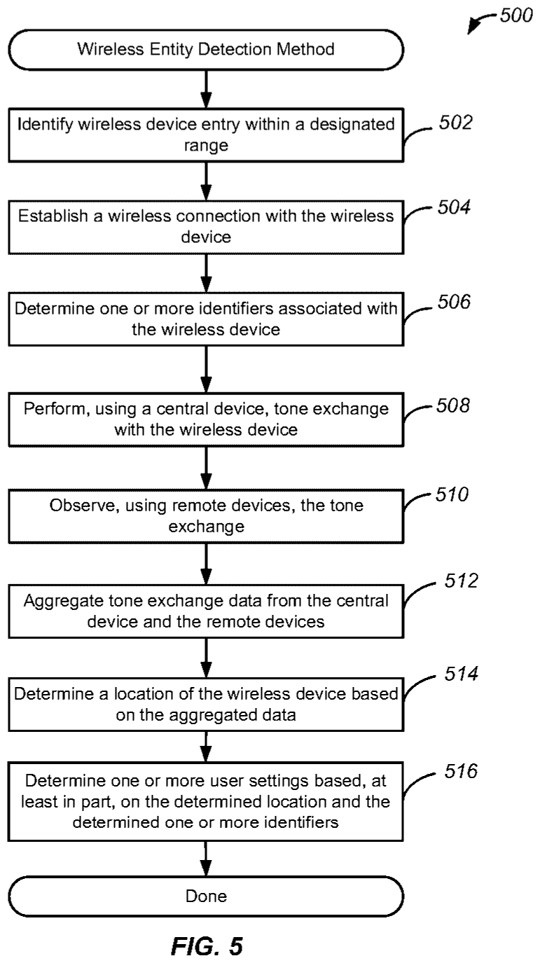

FIG. 5 illustrates diagram of another method for entity detection, performed in accordance with some embodiments. As similarly discussed above, identification features and location features of wireless connections may be used to identify and locate an entity, such as a wireless device, within an operational environment, and also apply custom settings based on such identity and location. As will be discussed in greater detail below, a method, such as method 500, may be performed to implement such identification and location of a wireless device associated with a user within a vehicular environment, such as an automobile, as well as facilitate the application of custom parameters and settings at the user's location within the automobile and specific to that user.

Method 500 may perform operation 502 during which a wireless device entry may be identified within a designated range. The wireless device, also referred to as a peripheral wireless device, may enter within a designated distance of the automobile and a central wireless device implemented within the automobile. The designated distance may be a range of a wireless network supported by the central wireless device. Accordingly, once the peripheral wireless device enters within range of the central wireless device, the peripheral wireless device may be detected. Such detection may be performed via one or more network detection techniques, such as the use of beacons and/or advertisement frames implemented in accordance with a wireless communications protocol, such as a Bluetooth protocol.

Method 500 may perform operation 504 during which a wireless connection may be established with the wireless device. Accordingly, in response to detecting the peripheral wireless device within the designated distance, the central wireless device may perform wireless connection operations to establish a network connection with the peripheral wireless device. Such wireless connection operations may be performed in accordance with a wireless communications protocol, such as a Bluetooth protocol.

Method 500 may perform operation 506 during which one or more identifiers associated with the wireless device may be determined. During wireless connection establishment and subsequent data exchange, data values may be exchanged that include one or more identifiers configured to identify the peripheral wireless device and/or a user of the peripheral wireless device. As similarly discussed above, such identifiers may include one or more hardware identifiers associated with the peripheral wireless device. Moreover, the identifiers may include identifiers obtained from application data transmitted via the wireless network connection. In one example, the identifiers may be obtained from an application executed by the central wireless device. More specifically, an application executed on the central wireless device may use identifiers obtained from a user login to identify a user of the peripheral wireless device. Such an application may be one created by the manufacturer of the automobile and may support connectivity between features of the automobile and information display and user controls presented on a user interface of the peripheral wireless device via a corresponding application executed on the peripheral wireless device. In this way additional identifiers specific to the user of the peripheral wireless device may be identified and authenticated to determine an identity of the user. In various embodiments, additional identifiers such as a network identifier or provisioned device token may be obtained. Moreover, identified patterns or “fingerprints” of wireless features may also be obtained that are specific to the peripheral wireless device.

Method 500 may perform operation 508 during which a tone exchange may be performed between the wireless device and a central wireless device. In various embodiments, the tone exchange is implemented via channel sounding features of the wireless network connection. For example, the connection may be a Bluetooth connection, and channel sounding capabilities of the Bluetooth connection may be used to obtain various distance estimation metrics. More specifically, the peripheral wireless device may use a channel sounding link of the wireless connection to transmit a designated signal, such as a tone, to the central wireless device. The central wireless device may obtain various measurements that may include phase and/or time data as may be obtained via an IQ capture unit. In this way, the tone exchange may include the peripheral wireless device transmitting a tone, and the central wireless device capturing phase and/or time data based on the received tone at the location of the central wireless device. Moreover, because a channel sounding link is used, other links of the wireless connection may be used for other purposes. Accordingly, channel sounding operations may support coexistence with other Bluetooth operations, such as data packet exchange.

Method 500 may perform operation 510 during which remote wireless devices may be used to observe the tone exchange. As similarly discussed above, several remote wireless devices may be positioned in different locations of the automobile configured to provide locating capabilities across all designated locations within the automobile. Accordingly, the location of the remote wireless devices may be configured and implemented based on the configuration of the designated locations, which may be seats. The remote wireless devices may observe the channel sounding operations passively, and thus may eavesdrop the tone exchange and other channel sounding operations that occur between the peripheral wireless device and the central wireless device. In this way, the remote wireless devices also capture phase and/or time data based on the received tone at their respective locations.

Method 500 may perform operation 512 during which tone exchange data may be aggregated from the central wireless device and the remote wireless devices. As similarly discussed above, a processing device included in the central wireless device may collect phase and/or time data from the remote wireless devices via a bus or other communications interface. Accordingly, the processing device may have access to phase and/or time data collected by the central wireless device as well as the remote wireless devices.

Method 500 may perform operation 514 during which a location of the wireless device may be determined based on the aggregated data. The processing device may use the phase and/or time data to generate an estimated distance for each set of phase and/or time measurements corresponding to each of the central wireless device and the remote wireless devices. The processing device may perform one or more triangulation computations based on the estimated distance to generate an estimated location of the peripheral wireless device. As similarly discussed above, the estimated location may be mapped to a designated location which may be identified as the designated location of the peripheral wireless device and the identified user.

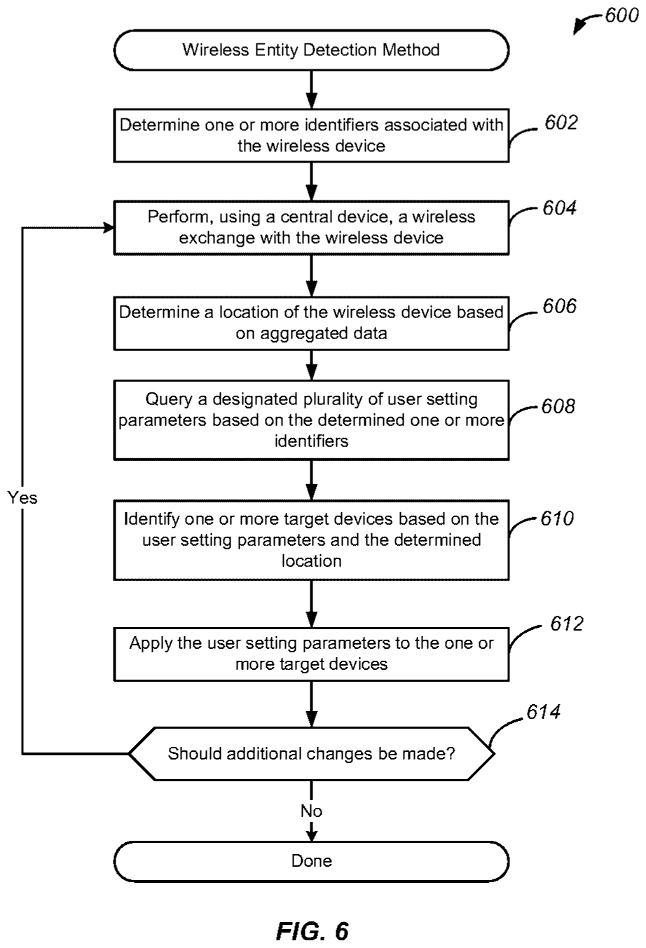

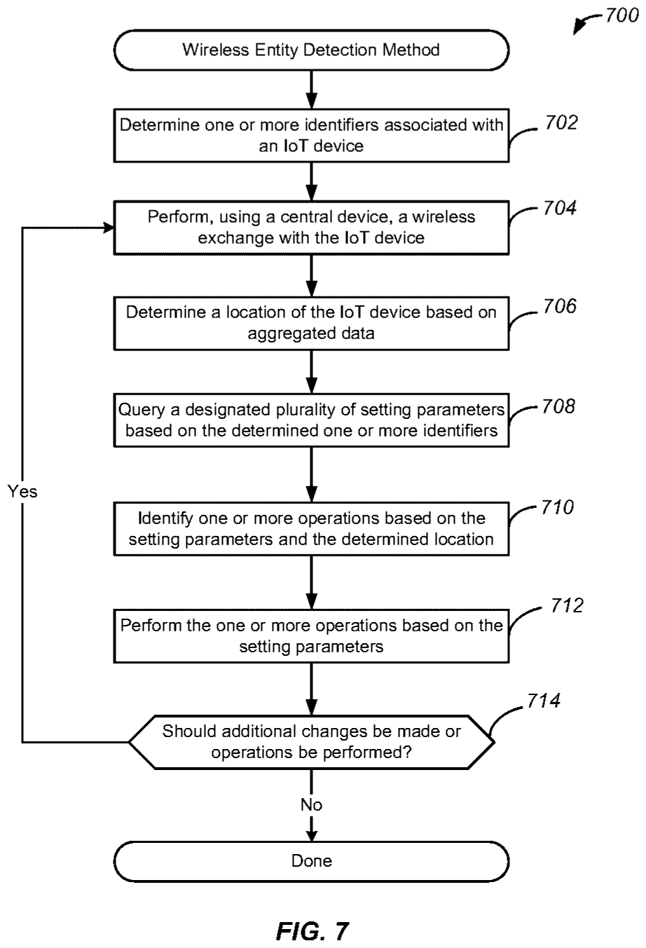

Method 500 may perform operation 516 during which one or more user settings may be identified based, at least in part, on the determined location and the determined one or more identifiers. In various embodiments, the determined location may be mapped to a set of user setting parameters. As will be discussed in greater detail below with reference to FIG. 6 and FIG. 7, the user setting parameters may identify a plurality of settings to be applied at the designated location for the identified user. For example, the plurality of settings may identify a designated seat position for components of the seat at the designated location, a designated listening volume for speakers at the designated location, and designated climate control settings at the designated location. In various embodiments, the user setting parameters may be user-defined, and may have been previously stored in memory. In this way, a combination of a determined identity and designated location may be used to selectively identify user settings applied to a user's location responsive to identifying their presence.

FIG. 6 illustrates diagram of an additional method for entity detection, performed in accordance with some embodiments. As similarly discussed above, identification features and location features of wireless connections may be used to identify and locate an entity, such as a wireless device, within an operational environment, and also apply custom settings based on such identity and location. As will be discussed in greater detail below, a method, such as method 600, may be performed to leverage such identity and location determinations to selectively apply user setting parameters responsive to determining their identity and identifying their location within an operational environment.

Method 600 may perform operation 602 during which one or more identifiers associated with the wireless device may be determined. As similarly discussed above, such identifiers may be obtained once a peripheral wireless device enters within range of a central wireless device implemented in an operational environment, such as an automobile, and a wireless connection is established. In one example, such identifiers may be obtained as part of wireless connection establishment, or some other validation or authentication operation. The one or more identifiers may be unique identifiers that are specific to the entity, which may be a user of the peripheral wireless device.

Method 600 may perform operation 604 during which a wireless exchange may be performed between the wireless device and a central wireless device. In various embodiments, the wireless exchange may include one or more ranging operations using ranging features of the established wireless connection. Accordingly, during operation 604 the peripheral wireless device and the central wireless device may perform channel sounding operations in which the peripheral wireless device transmits a tone and the central wireless device obtains measurements including phase and/or time data. As also discussed above, various remote wireless devices may also observe the exchange and may also obtain measurements including phase and/or time data at their respective locations.

Method 600 may perform operation 606 during which a location of the wireless device may be determined based on aggregated data. Accordingly, the processing device may use the aggregated phase and/or time data to generate estimated distances and an estimated position of the peripheral wireless device within the operational environment. As similarly discussed above, such an estimated location may be mapped to a designated location within the operational environment, such as a particular seat within the automobile.

Method 600 may perform operation 608 during which a designated plurality of user setting parameters may be queried based on the determined one or more identifiers. As similarly discussed above, a processing device may query user setting parameters stored in memory based on the determined identity of the user, and may identify and retrieve a set of user setting parameters associated with that user. Such user setting parameters may have been previously stored by the user or may have previously been recorded based on a previous time the user was in the automobile. In some embodiments, the user setting parameters may be imported via an application executed on the central wireless device or may be imported from the peripheral wireless device via the wireless connection. During operation 608, user setting parameters may be selected if they store an identifier that matches the unique identifier of the identified user.

Method 600 may perform operation 610 during which one or more target devices may be identified based on the user setting parameters and the determined location. In various embodiments, a plurality of target devices may be identified based on a mapping of the user setting parameters to one or more known devices within the operational environment. In the example of an automobile, a user setting for climate control may be mapped to one or more climate control devices such as a heater and fan. Moreover, in dual and multi-climate control environments, particular fans and vents may be selected based on the determined location. In this way, a type of device within the automobile and specific devices may be selected based on the determined designated location, and their operation may be configured based on the user setting associated with the identified user. During operation 610 a plurality of target devices may be selected based on the user setting parameters where each identified user setting is mapped to one or more target devices. Such a mapping may be determined by an entity, such as a manufacturer, and may be configured to map each type of user setting to a target device or a set of target devices.

Method 600 may perform operation 612 during which the user setting parameters may be applied to the one or more target devices. Thus, the identified target devices may be selected based on the determined location and may be configured based on the user setting parameters. In this way, the user setting parameters may be applied at the identified location of the user for the identified user in response to the user entering the automobile and as part of wireless connection and ranging operations.

Method 600 may perform operation 614 during which it may be determined if additional changes should be made. Such a determination may be made if a change in a position of the user is detected. In another example, such a determination may be made if another peripheral wireless device has been detected. Accordingly, additional iterations of method 600 may be performed in response to changes in a position of a user, or detection of additional users also entering the automobile. If it is determined that additional changes should be made, method 600 may return to operation 604. If it is determined that no additional changes should be made, method 600 may terminate.

FIG. 7 illustrates diagram of another method for entity detection, performed in accordance with some embodiments. As similarly discussed above, identification features and location features of wireless connections may be used to identify and locate an entity, such as a wireless device, within an operational environment, and also apply custom settings based on such identity and location. In various embodiments, the wireless device may be an IoT device deployed as part of an IoT system that includes multiple IoT devices communicating with each other within the operational environment. As will be discussed in greater detail below, a method, such as method 700, may be performed to leverage identity and location determinations to selectively apply IoT device-specific setting parameters responsive to determining an identity and location of an IoT device within an operational environment.

Method 700 may perform operation 702 during which one or more identifiers associated with an IoT device may be determined. As similarly discussed above, such identifiers may be obtained once a peripheral wireless device enters within range of a central wireless device implemented in an operational environment. In one example, the peripheral wireless device may be an IoT device, and the central wireless device may be a central wireless device within an IoT system, such as a security system or climate control system. A wireless connection may be established between the peripheral wireless device and the central wireless device. In one example, the identifiers may be obtained as part of wireless connection establishment, or some other validation or authentication operation. The one or more identifiers may be unique identifiers that are specific to an entity associated with the peripheral wireless device, which may be a user associated with a user account managed by the IoT system. As similarly discussed above, the IoT system may be part of a security system, such as a video surveillance system. In some embodiments the IoT system may be a building automation system, such as a lighting system or a spatial audio system.

Method 700 may perform operation 704 during which a wireless exchange may be performed between the IoT device and a central wireless device. In various embodiments, the wireless exchange may include one or more ranging operations using ranging features of the established wireless connection. Accordingly, during operation 704 the peripheral wireless device and the central wireless device may perform channel sounding operations in which the peripheral wireless device transmits a tone and the central wireless device obtains measurements including phase and/or time data. As also discussed above, various remote wireless devices may also observe the exchange and may also obtain measurements including phase and/or time data at their respective locations. In some embodiments, the remote wireless devices may be other IoT devices implemented within the IoT system.

Method 700 may perform operation 706 during which a location of the IoT device may be determined based on aggregated data. Accordingly, the processing device included in the central wireless device may use the aggregated phase and/or time data to generate estimated distances and an estimated position of the peripheral wireless device within the operational environment. As similarly discussed above, such an estimated location may be mapped to a designated location within the operational environment. More specifically, the estimated location of the peripheral wireless device may be mapped to a designated location within the IT system, such as a particular room of a house or a particular zone of a warehouse or other commercial facility.

Method 700 may perform operation 708 during which a designated plurality of setting parameters may be queried based on the determined one or more identifiers. As similarly discussed above, the processing device may query setting parameters stored in memory based on the determined identity of the peripheral wireless device and its associated entity, and may identify and retrieve a set of setting parameters associated with the peripheral wireless device and its associated entity. Such setting parameters may have been previously stored by the entity, which may be an administrator or user, or may have previously been recorded based on a previous instance of the entity being in the operational environment. In some embodiments, the setting parameters may be imported via an application executed on the central wireless device or may be imported from the peripheral wireless device via the wireless connection. During operation 708, setting parameters may be selected if they store an identifier that matches the unique identifier of the identified peripheral wireless device and associated entity.

Method 700 may perform operation 710 during which one or more operations may be identified based on the setting parameters and the determined location. In various embodiments, a plurality of target devices may be identified based on a mapping of the setting parameters to one or more known devices within the operational environment. In the example of a climate control system for a house, one or more climate control settings may be mapped to one or more climate control devices such as a heater and fan at a particular location within the house. In this way, a type of device within the house and specific devices selected based on the determined designated location may have their operation configured based on the selected setting parameters. During operation 710, a plurality of target devices may be selected based on the setting parameters where each identified setting is mapped to one or more target devices. Such a mapping may be determined by an entity, such as a manufacturer, administrator, or user, and may be configured to map each type of setting to a target device or a set of target devices.

Method 700 may perform operation 712 during which the one or more operations may be performed based on the setting parameters. Thus, the identified target devices may be selected based on the determined location and may be configured based on the setting parameters. In this way, the setting parameters may be applied at the identified location of the entity for the identified entity in response to the entity entering the operational environment and as part of wireless connection and ranging operations.

Method 700 may perform operation 714 during which it may be determined if additional changes should be made or operations should be performed. Such a determination may be made if a change in a position of the peripheral wireless device is detected. In another example, such a determination may be made if another peripheral wireless device has been detected. Accordingly, additional iterations of method 700 may be performed in response to changes in a position of a peripheral wireless device, or detection of additional peripheral wireless devices also entering the operational environment. If it is determined that additional changes should be made or operations should be performed, method 700 may return to operation 704. If it is determined that no additional changes or operations should be performed, then method 700 may terminate.

Although the foregoing concepts have been described in some detail for purposes of clarity of understanding, it will be apparent that certain changes and modifications may be practiced within the scope of the appended claims. It should be noted that there are many alternative ways of implementing the processes, systems, and devices. Accordingly, the present examples are to be considered as illustrative and not restrictive.

What is claimed is:

1. A method comprising:
determining, using one or more processors of a central wireless device, one or more identifiers associated with a peripheral wireless device;
performing, using the one or more processors, a wireless exchange with the peripheral wireless device, the wireless exchange comprising one or more channel sounding operations compatible with a wireless communications protocol;
determining a plurality of estimated distances based on channel sounding data obtained by the central wireless device and received from a plurality of remote wireless devices based on the wireless exchange; and
determining a location and identity of the peripheral wireless device within an operational environment based on the plurality of estimated distances and the one or more identifiers.

2. The method of claim 1, wherein the one or more identifiers are configured to identify a user of the peripheral wireless device.

3. The method of claim 2, wherein the one or more identifiers are determined based on application data from an application executed by the central wireless device, and wherein the one or more identifiers comprise authentication information associated with the user.

4. The method of claim 1, wherein the plurality of remote wireless devices are positioned at different locations than each other and the central wireless device.

5. The method of claim 1 further comprising:
generating a plurality of estimated distances comprising an estimated distance for the central wireless device and each of the plurality of remote wireless devices based on data included in the channel sounding data.

6. The method of claim 5 further comprising:
determining an estimated location of the peripheral wireless device within an operational environment based on the plurality of estimated distances; and
mapping the estimated location to a designated location within the operational environment based on a designated spatial mapping.

7. The method of claim 6 further comprising:
identifying a plurality of user setting parameters based, at least in part, on the one or more identifiers;
identifying one or more target devices based on the user setting parameters and the designated location; and
applying the user setting parameters to the one or more target devices.

8. The method of claim 1, further comprising:
sending, from the central wireless device, a synchronization signal to the plurality of remote wireless devices to synchronize data measurements during the channel sounding operations.

9. The method of claim 1, wherein the channel sounding operations are performed using a channel sounding link of a Bluetooth channel.

10. A system comprising:
a plurality of remote wireless devices configured to receive wireless signals compatible with a wireless communications protocol; and
a central wireless device comprising one or more processors configured to:
determine one or more identifiers associated with a peripheral wireless device;
perform a wireless exchange with the peripheral wireless device, the wireless exchange comprising one or more channel sounding operations compatible with a wireless communications protocol;
determine a plurality of estimated distances based on channel sounding data obtained by the central wireless device and received from a plurality of remote wireless devices based on the wireless exchange; and
determine a location and identity of the peripheral wireless device within an operational environment based on the plurality of estimated distances and the one or more identifiers.

11. The system of claim 10, wherein the one or more identifiers are configured to identify a user of the peripheral wireless device, wherein the one or more identifiers are determined based on application data from an application executed by the central wireless device, and wherein the one or more identifiers comprise authentication information associated with the user.

12. The system of claim 10, wherein the plurality of remote wireless devices are positioned at different locations than each other and the central wireless device.

13. The system of claim 10, wherein the one or more processors are further configured to:
generate a plurality of estimated distances comprising an estimated distance for the central wireless device and each of the plurality of remote wireless devices based on data included in the channel sounding data;
determine an estimated location of the peripheral wireless device within an operational environment based on the plurality of estimated distances; and
map the estimated location to a designated location within the operational environment based on a designated spatial mapping.

14. The system of claim 13, wherein the one or more processors are further configured to:
identify a plurality of user setting parameters based, at least in part, on the one or more identifiers;
identify one or more target devices based on the user setting parameters and the designated location; and
apply the user setting parameters to the one or more target devices.

15. The system of claim 10, wherein the one or more processors are further configured to:
send a synchronization signal to the plurality of remote wireless devices to synchronize data measurements during the channel sounding operations.

16. A device comprising:
one or more processors of a central wireless device configured to:
determine one or more identifiers associated with a peripheral wireless device;
perform a wireless exchange with the peripheral wireless device, the wireless exchange comprising one or more channel sounding operations compatible with a wireless communications protocol;
determine a plurality of estimated distances based on channel sounding data obtained by the central wireless device and received from a plurality of remote wireless devices based on the wireless exchange; and
determine a location and identity of the peripheral wireless device within an operational environment based on the plurality of estimated distances and the one or more identifiers.

17. The device of claim 16, wherein the one or more identifiers are configured to identify a user of the peripheral wireless device, wherein the one or more identifiers are determined based on application data from an application executed by the central wireless device, and wherein the one or more identifiers comprise authentication information associated with the user.

18. The device of claim 16, wherein the one or more processors are further configured to:
generate a plurality of estimated distances comprising an estimated distance for the central wireless device and each of the plurality of remote wireless devices based on data included in the channel sounding data;
determine an estimated location of the peripheral wireless device within an operational environment based on the plurality of estimated distances; and
map the estimated location to a designated location within the operational environment based on a designated spatial mapping.

19. The device of claim 18, wherein the one or more processors are further configured to:
identify a plurality of user setting parameters based, at least in part, on the one or more identifiers;
identify one or more target devices based on the user setting parameters and the designated location; and
apply the user setting parameters to the one or more target devices.

20. The device of claim 16, wherein the one or more processors are further configured to:
send a synchronization signal to the plurality of remote wireless devices to synchronize data measurements during the channel sounding operations.
